(19) United States
(12) Patent Application Publication
(10) Pub. No.: US 2020/0290219 A1
(43) Pub. Date: Sep. 17, 2020

(54) FOLDING KNIFE

(71) Applicant: Slice, Inc., San Jose, CA (US)

(72) Inventors: Thomas John Scimone, Campbell, CA (US); Scot Herbst, Santa Cruz, CA (US); William W. Hunter, Santa Cruz, CA (US); Robert Joseph Gallegos, Fremont, CA (US)

(21) Appl. No.: 16/886,283

(22) Filed: May 28, 2020

Related U.S. Application Data
(63) Continuation of application No. 15/947,748, filed on Apr. 6, 2018.
(60) Provisional application No. 62/482,549, filed on Apr. 6, 2017.

(51) Int. Cl. B26B 1/04; B26B 1/10; B26B 5/00

(52) U.S. Cl. CPC B26B 1/042; B26B 1/046; B26B 5/00; B26B 1/10

(57) ABSTRACT

A folding knife is described herein. The folding knife includes a release actuator that provides three knife positions: a secured closed position, a secured open position, and an intermediate unsecured position in between the two secured positions, and that opens and closes the folding knife easily and safely. A triple-purpose pivot ring provides an index finger grip, an attachment point, and a pivoting mechanism. The release actuator allows for one-handed operation. A blade holder comprises a blade lock that has two positions, one of which locks the blade into position in the blade holder, while the other position unlocks it. The blade lock may be a push button that unlocks the blade while pressing it down, and that automatically return the lock into its locked position by action of a spring, in particular a leaf spring.

### RELATED APPLICATIONS

This application claims the benefit of U.S. Nonprovisional patent application Ser. No. 15/947,748 filed Apr. 6, 2018, and U.S. Provisional Patent Application No. 62/482,549 filed Apr. 6, 2017, both of which are hereby incorporated by reference in their entirety.

### FIELD OF THE INVENTION

The application is in the field of cutting knives.

### BACKGROUND

Folding knives typically have multiple parts, including the blade, a handle, and a central hinge component that joins them. Many different types of folding knives exist. In some models it is difficult to pivot the blade into the open position, especially when using one hand. When opened, in some models the blade does not stay reliably and stably open, and the blade may close again unexpectedly, for example, as less pressure is applied to the cutting edge, causing potential for injuries. Another problem that occurs is that the closing operation is awkward, cannot be performed one-handed, and/or has potential for injury. Yet another problem relates to folding knives that do not reliably stay in the closed position, especially models that open more easily.

Other problems relate to securing the blade into position in the folding knife, in particular within a blade holder used in knives with removable and/or exchangeable blades. Some knives with blade holders are unreliable or unsafe in securing the blade in the holder, or the procedure to remove and exchange the blade is awkward, complicated, or unsafe.

Therefore, there is a need in the art for a folding knife that improves one or more of these problems, or additional problems. In particular, there is a need for a folding knife that better secures the blade, prevents the blade from moving, and the user from injury when the knife is in open or closed position, or in between—while using the blade, while storing the blade, and while folding the blade away. In particular, there is a need for a folding knife that can be easily opened and closed, preferably with one hand. Furthermore, there is a need for a knife with a blade holder, in particular in knives with exchangeable blades, where the blade can be locked in place, but can be easily unlocked, for example, for exchanging the blade for a new one, or for one of a different type. These and other features and advantages of the present invention will be explained and will become apparent to one skilled in the art through the description that follows.

### SUMMARY

The present invention generally relates to folding knives. Specifically, embodiments of the present invention relate to folding knives with a release actuator that is configured to provide three knife positions: a secured closed position, a secured open position, and an intermediate unsecured position in between the two secured positions, and that opens and closes the folding knife easily and safely. In a particular embodiment, a triple-purpose pivot ring provides an index finger grip and an attachment point for, for example, a carabiner, in addition to a pivoting mechanism. In another embodiment, the release actuator is located within the pivot ring, and takes the form of a trigger that allows one-handed operation. In yet another embodiment, a blade holder comprises a blade lock that is configured with two positions, one of which locks the blade into position in the blade holder, while the other position unlocks it. In still another embodiment, the blade lock is configured as a push button that unlocks the blade while pressing it down, and that is configured to automatically return the lock into its locked position by action of a spring, in particular a leaf spring.

### BRIEF DESCRIPTION OF THE DRAWINGS

FIG. 1 is an example of a folding knife;

FIG. 2 is an example left side view of the folding knife;

FIG. 3 is an example right side view of the folding knife;

FIG. 4 is an example top view of the folding knife;

FIG. 5 is an example bottom view of the folding knife;

FIG. 6 is an example front view of the folding knife;

FIG. 7 is an example rear view of the folding knife;

FIG. 8 is a first example exploded view of the folding knife; and

FIG. 9 is a second example exploded view of the folding knife.

### DETAILED SPECIFICATION

The present invention generally relates to folding knives. Specifically, embodiments of the present invention relate to folding knives with a release actuator that is configured to provide three knife positions: a secured closed position, a secured open position, and an intermediate unsecured position in between the two secured positions, and that opens and closes the folding knife easily and safely. In a particular embodiment, a triple-purpose pivot ring provides an index finger grip and an attachment point for, for example, a carabiner, in addition to a pivoting mechanism. In another embodiment, the release actuator is located within the pivot ring, and takes the form of a trigger that allows one-handed operation. In yet another embodiment, a blade holder comprises a blade lock that is configured with two positions, one of which locks the blade into position in the blade holder, while the other position unlocks it. In still another embodiment, the blade lock is configured as a push button that unlocks the blade while pressing it down, and that is configured to automatically return the lock into its locked position by action of a spring, in particular a leaf spring.

According to an embodiment of the present invention, the folding knife described herein may comprise a blade section and a handle section that are joined by a central hinge, around which the knife sections fold together, such that the blade section can fold away into an inner chamber between outer panels of the handle section, that is configured to accept the blade section. The two sections may generally be of equal or similar length, or the blade section may be shorter so that the blade section may fold away completely into the handle section, in which case the handle section will be longer.

According to an embodiment of the present invention, the folding knife described herein may be comprised of a blade section and a handle section, wherein the two sections are pivotably joined by a hinge component at their pivot point, for example a pivot ring. The pivot ring may be used to attach the knife to objects including hooks, carabiners and clothing, and in parallel serves as an additional grip element for a fingers or thumb when the knife is open and in use.

According to an embodiment of the present invention, the blade section and the handle section may be pivotably joined by a pivot pin at their pivot point, for example, each section may be configured with at least one hole to accept a pin or peg, and the pin may be configured to fit the hole such that it allows pivoting the two sections around the pin into an open position. The pin may be secured in place by an end piece on each of its opposing sides which may be configured any suitable way, for example, flush with the surface of the handle section (for example, an outer panel thereof), recessed slightly below the surface, or slightly protruding from the surface.

According to an embodiment of the present invention, the blade section may comprise a blade holder configured to securely hold the blade, and a blade configured to securely connect to the blade holder. The blade may be configured with a spine and a cutting edge on opposite sides of its width, and a blade tip and a back end on opposite sides of its length.

According to an embodiment of the present invention, the handle section may have two opposite ends, a hinge end at the front and a back end on the other side, and the handle section's hinge end may be configured to form a hinge together with the blade holder, when the hinge end of the blade holder is pivotally mounted thereto by way of a central hinge component such as a pivot ring, cylinder, peg or pin. The handle section may have a top/left and bottom/right broad side opposite from each other, and a top/spine and bottom/“belly” narrow side opposite from each other. The spine side of the handle section may be on the same side as the spine of the blade with the knife in open position, but with the knife in closed position, the spine side of the handle may be on the opposite side as the spine of the blade, for example, it may be on the same side as the blade's cutting edge/“belly” side when the blade switches orientation as it is folded away.

According to an embodiment of the present invention, the knife may be configured with a closed position in which the blade section is pivoted fully inwards and sits in a chamber configured in the handle section to accommodate the dimensions (length, width) and shape of the blade section, with an open position in which the blade section is pivoted fully outward and away from the handle, and with an intermediary position located anywhere between the fully closed position and the fully open positions.

According to an embodiment of the present invention, a release actuator may be configured in the handle section in a position so that it may be conveniently reached when holding the handle, in particular on a broad side of the handle section towards the handle section's hinge end. The location may be adapted to be more easily reached by the thumb, or by one or more finger, in particular for one-handed release operation. For example, the release actuator may be configured on the narrow/spine side of the handle section, for example, towards the handle section's hinge end. Still alternatively, the release actuator may be configured in the hinge part of the handle section (for example, on the inside circumference of the pivot hinge cylinder), to be pushed like a trigger, for example, by the index finger. This has the advantage of allowing one-handed operation to release the blade section.

According to an embodiment of the present invention, the release actuator may be configured with a first and a second position, the first position of the actuator preventing release of/securing the blade section in both the closed and the open position of the folding knife, and the second position of the actuator permitting its release and allowing the blade section to move into the intermediary position, which corresponds to any position between the two secured positions of the folding knife (open or closed). To move the knife from its closed to its released intermediary and finally its open position, the release actuator may be actuated and moved into its second position, thus releasing the blade holder, which may now be pivoted outwards out of the chamber of the handle section by manually pulling an accessible part of the blade section, until it reaches the open position. Upon reaching the open position, the release actuator may automatically return to its first position, for example, by way of a spring, and the release actuator, returned to its first position, may then again secure the blade section in its open position.

In an embodiment of the present invention, the release actuator may be configured as a push button, that may be moved into the second position which permits release of the blade holder by pushing the button inwards. The push button may be configured so that after the blade holder reaches the open position, the push button will automatically return to the first position that prevents release (for example, now locks the blade into the open position), until the button is pushed again. Pushing the button with the knife in open position similarly may release the blade holder, which can then be returned into the closed position. The push button may be configured so that once the closed position is reached, it automatically returns to the first position that prevents release of the blade holder.

In an embodiment of the present invention, the release actuator or button may, for example, be configured substantially cylindrical, and the parts of the handle section may be configured with a chamber to fits its dimensions in both its first and its second position, for example, in the first position there will be room to move into the second position, such as the part of the chamber below, and vice versa (in the second position there will be room to move into the first position, such as the part of the chamber above). A part of the chamber may be configured with a means to automatically return the release actuator into its first position, such as a coiled spring, leaf spring, compressible foam or other material/structure able to store and release energy in directed form.

In an embodiment of the present invention, the release actuator or push button may comprise a coiled spring that together with the walls of the chamber of the handle section may be configured to automatically return the actuator from the first to the second position and vice versa (from the second to the first position), when the fully closed or fully open positions are reached. The actuator when located in the handle section generally may have an outwards facing surface (at the surface of the handle) and an inwards facing surface (inside the handle). The outwards facing surface may serve as contact surface to actuate the button, and the inwards facing surface may contact the spring which may be located in the part of the chamber of the handle section below the actuator, and will be compressed when the actuator is pushed inwards into the second position. The push actuator may be configured so that once the blade holder reaches the fully open or closed position; the spring may be automatically released and returns the actuator into the first position.

In an embodiment of the present invention, the release actuator or button may be configured substantially cylindrical in form of a barbell shape with two ends, an outer and an inner end. Each end has a larger diameter than the middle part in between, the outer end provides the surface to press onto the release actuator, and the inner end engages with the spring on its inner surface, and the sides of the inner end engage with two correspondingly shaped notches 830 and 835 (or recesses) in the circular hinge-end part of the blade holder when the knife is in its fully closed or fully opened position, and thus blocks release of the blade holder in either position. Pushing the release actuator downwards moves its inner end below its notch-engaging/blocking position, allows the blade holder to move/pivot in outwards direction, and thus releases the blade section. The diameter of the middle part of the release actuator cylinder is configured so that the middle part does not engage with the recess/notch of the blade holder, and allows its release as described. For example, the middle part may be a cylinder of smaller diameter that fits into each notch with space to spare, so that the surfaces of blade holder and the middle part of the cylinder do not engage. While in the process of moving the blade section outwards or inwards, the un-notched circular part of the hinge end of the blade holder will block the button from returning into its position, until one of the two notches is reached. Thus by spacing the notches accordingly, corresponding to the positions in a fully opened/closed knife, one notch may be configured to provide a secured open position that prevents the blade to close, and the other notch may be configured to provide a secured closed position that prevents the blade from opening, unless the release actuator is actuated, for example, the button is pressed, to disengage its notch-engaging part (for example, its inner end with larger diameter) by moving it downwards.

In an embodiment of the present invention, the cylinder of the release actuator or button may be substantially solid, with the spring or compressible structure/material located in the part of the chamber under the inner surface of the inner end of the release actuator. Alternatively, the release actuator may be hollow, with a central cavity configured to accept, for example, a coiled spring/compressible material, or a part thereof. The central cavity may extend from the inwards facing surface of the release actuator towards the outwards facing surface, for example up to ¼ of its length, up to ½ of its length, up to ¾ of its length, or just below the outwards facing surface. The dimensions of the spring/compressible material are configured accordingly, to allow its compression to generate enough force to return the release actuator into the first position.

According to an embodiment of the present invention, the handle section may comprise a recess in the chamber wall on its bottom/belly side, for example in one or in both of the handle halves that may be configured to allow easy access to the blade holder. This allows the spine and side of the blade holder to be easily grabbed to open the knife by pulling the blade holder out of the handle section, once the blade section has been released by the release actuator. The recess may have finger-width length and a depth sufficient to provide good grip, depending on the material of the spine of the blade holder. The corresponding accessible area of the spine and side of the blade holder may be textured or otherwise adapted with surface features or materials to increase friction and allow it to be easily gripped without slipping. For example, such features/materials may include grooves, raised surface/embossing, hatched engraving, soft or rough anti-slip inlays such as rubber or silicone inlay or sand paper type inlays.

The blade may be permanent or exchangeable, and may be secured in the blade holder by any suitable means, including one or more of numerous fasters such as rivets, bolts and screws, friction fit, adhesives, and combinations thereof. For example, the blade holder may be configured to provide a friction fit by its tight fitting structure. Alternatively or additionally, the blade holder may be configured from two halves joined securely by screws, and the friction between the two halves and the blade may keep the blade secured. Alternatively or additionally, the blade holder may be configured with one, two or more chambers to hold leaf springs, which create a force against an opposite structure, for example, the opposite wall, or a second leaf spring located opposite the first, so that the force created securely holds the blade in place. Alternatively or additionally, the blade may be configured with a notch to be secured by a corresponding structure in the blade holder such as the blade lock as described herein for a removable/exchangeable blade. In case of a permanent blade, the lock does not need to be configured with a second unsecured position as described. If the blade is permanent, alternatively or additionally, it may be secured by adhesives or a friction fit as described herein below.

According to an embodiment of the present invention, the blade holder may be configured for a removable/exchangeable blade, and may comprise a blade lock. The blade lock may be configured with two positions, one of which locks the blade into position in the blade holder, while the other position unlocks it. In particular, the blade lock may be configured with a locking protrusion that engages a corresponding notch in the blade to lock it in place, and may be further configured to move the locking protrusion out of the notch to release the blade for removal or exchange. For example, the blade lock may be configured as a push button that unlocks the blade while pressing the outer button surface down and thus moving the connected locking protrusion out of the notch of the blade. The blade lock may be further configured to automatically return the locking protrusion into its locked position when the push button is released by action of a spring, for example a leaf spring configured below the lock inside the blade holder, that upon release of pressure on the button springs back into its original shape and thus pushes the lock (including button and locking protrusion) up again, moving the lock, and its locking protrusion, back into its locking position that engages the notch in the blade. The leaf spring may be located inside a recess of the blade holder configured to hold a spring of suitable compressibility to return the push button into original position upon its release. The blade lock allows the blade to be easily exchanged with a new or different blade of a different type (for example, different material or shape, for example, serrated/unserrated blade, ceramic/metal blade, and the like), but safely locked once the desired blade is in place.

In an embodiment of the present invention, a portion of the blade inside the blade holder may be configured to engage with a protruding structure of the blade holder, for example, the lock, and thus prevent movement of the blade when engaged, for example, the blade does not pull out, for example, when the blade catches during use. For example, the blade may be configured with a notch, slot or hole to engage a lock as described for removable/exchangeable blades, or to engage a corresponding structure of the blade holder such as a protrusion, pin, peg or corner, and thus secure a permanent blade.

According to an embodiment of the present invention, the blade holder may be configured with a removable/exchangeable blade, and may additionally be configured with a friction means to increase friction sufficiently when the blade is unlocked to prevent the blade from slipping out, but allow it to be pulled out or inserted easily. For example, such a friction means may take the form of a leaf spring comprised in a recess of the blade holder and configured to make contact with one of the two broad sides of the blade, and press it towards a wall of the blade holder in contact with the opposite broad side of the blade with pressure high enough to prevent slippage but low enough to allow removal and insertion of the blade. Similarly, in case of a permanent blade, the leaf spring may be used to secure the blade alone or in combination with other fasteners, depending on the pressure that the leaf spring is configured to exert.

According to an embodiment of the present invention, the pivot hinge may be a pin or a peg, or may be a hollow cylinder, for example the cylinder as shown in the figures. The pivot hinge may be configured with an end cap, which may be attached to the pivot hinge using any suitable fastener as herein described. The cap allows to hold all components of the folding knife that are assembled onto the pivot hinge together, for example, the top handle half, the blade holder (with its two halves), and the bottom handle half For example, the pivot hinge may be a hollow cylinder whose two distal ends may be configured with holding means to keep the assembled knife parts in place. For example, a thread at one or both of the cylinder's distal ends, configured to allow attachment of one or two end caps. If only one distal end is threaded, the other end may be configured with a stopper, for example, a slightly broader rim of the cylinder that holds the knife parts assembled onto the cylinder in place. For example, the pivot hinge may be a hollow cylinder configured with one thread and a correspondingly threaded cap at one of its distal ends, and a broader rim as a stopper configured at its other end. Alternatively, the pivot hinge may be a pin or peg configured with a holding means such as a cap that may be screwed, glued, or otherwise attached by a fastener as described herein below onto one or both ends of the pin/peg, and the other end may be configured with a stopper.

According to an embodiment of the present invention, the blade may take any one of numerous forms suitable for use in a utility knife, such as trapezoidal, hooked, rectangular, and segmented for snap-off (for example, with one or more segments that can be removed from the blade to expose a fresh cutting edge). The cutting edge of the blade may take any one of numerous different configurations of cutting edges, including straight and serrated.

According to an embodiment of the present invention, the handle section may be made from multiple pieces, for example, two halves which may be substantially symmetrical or non-symmetrical with regard to their outer and/or inner shape, and their outer and/or inner surface profile. Alternatively or additionally, the handle may be configured with three pieces. The inner surface profile may be configured symmetrical or non-symmetrical to provide space for the blade holder and blade once folded in, and to accommodate symmetrical or non-symmetrical features such as the release actuator/push button, and related structures (for example, coiled spring and the space/chambers therefor). Each half may essentially be one piece or multiple pieces, for example, each half may have an outer panel, for example, to provide surface texture, surface protection, additional stability and/or decoration. The halves and other pieces of the handle may be assembled and fastened to each other using any method and any mechanical or chemical fastener, for example as described herein below, including for example, screws and/or adhesives.

According to an embodiment, the blade holder may be configured of multiple parts, in particular two halves, and the blade may be disposed symmetrically or non-symmetrically in between the two halves. For example, each half of the blade holder may be configured to provide part of a chamber to accommodate the blade, or alternatively, the blade may be disposed within a chamber in one of the halves, the blade-holding half, thus the non-blade holding half will provide one wall of the blade-holding chamber and be fastened to the blade-holding half to secure the blade, for example, using screws, showing the blade-holding half wire-framed, showing only the blade-holding but not the other half. Thus the inner shape and surface profile of the two halves may be substantially symmetrical (two blade holding halves) or non-symmetrical (one blade-holding half). The outer shape and surface profile may likewise be symmetrical or non-symmetrical, for example, one or both of the halves may be configured with a blade lock to secure a removable blade.

According to an embodiment of the present invention, the parts of the handle section and of the blade holder may be made of one or more materials, including plastics, thermoplastics, polymers, metals, and wood.

According to an embodiment of the invention, one or more of the handle and the blade holder, or any parts thereof, may be formed from a suitable thermoplastic material, which may include, for example, Acrylanitrile Butadiene Styrene (ABS), Polycarbonate (PC), Mix of ABS and PC, Acetal (POM), Acetate, Acrylic (PMMA), Liquid Crystal Polymer (LCP), Mylar, Polyamid-Nylon, Polyamid-Nylon 6, Polyamid-Nylon 11, Polybutylene Terephthalate (PBT), Polycarbonate (PC), Polyetherimide (PEI), Polyethylene (PE), Low Density PE (LDPE), High Density PE (HDPE), Ultra High Molecular Weight PE (UHMW PE), Polyethylene Terephthalate (PET), PolPolypropylene (PP), Polyphthalamide (PPA), Polyphenylenesulfide (PPS), Polystyrene (PS), High Impact Polystyrene (HIPS), Polysulfone (PSU), Polyurethane (PU), Polyvinyl Chloride (PVC), Chlorinated Polyvinyl chloride (CPVC), Polyvinylidenefluoride (PVDF), Styrene Acrylonitrile (SAN), Teflon TFE, Thermoplastic Elastomer (TPE), Thermoplastic Polyurethane (TPU), Engineered Thermoplastic Polyurethane (ETPU), or any combination thereof.

According to an embodiment, the knife may be assembled depending on the construction of its sections as described herein-above. For example, an interference fit (also known as a press fit or a friction fit) may be used. This may include an interference fit by force or temperature (thermal expansion or contraction). Alternatively or additionally, adhesive or mechanical fasteners (for example, screws, bolts, hooks, and the like), press fitting, ultrasonic welding, coatings, adhesive, or any combination thereof may be used. For example, the parts to be joined may be metal parts, and metal screws or bolts may be used to join them. The type of connection depends on the selected materials and the configurations of the parts involved, as will be apparent to a person of ordinary skill in the art.

According to an embodiment of the invention, a fastening element such as a hook, latch or similar may be configured in the parts of the blade holder or handle section to be joined. In this case, stronger materials may be used so that the parts remain intact during the strain of assembly. Alternatively or additionally, mechanical fasteners like screws, rivets, pins, nuts, push on lock nuts, or clips may be used. The mechanical fasteners may be molded in place, forced, glued or expanded into holes, inserted ultrasonically or inserted with heated probes. Mechanical fasteners may be used with suitable materials resilient enough to withstand the strain of fastener insertion and the stress around the fastener, depending on shape and thickness of the parts.

In another embodiment, the material of the parts to be joined may be plastics, which may be joined by ultrasonic welding, for example, transmittal of sonic pulses to the parts by a resonant vibrating tool called a horn, which causes two plastic materials to vibrate against each other. The vibration both heats and fuses the parts together, without need for glues or solvents. Plastic parts including those composed of blends or alloys of different resin families may be welded if their melting temperatures are within, for example, about 30° F. and their composition is compatible.

In another embodiment, the material of the parts to be joined may be thermoplastics that are softened by coating them with a solvent, then clamping or otherwise pressing the parts together to bond them upon evaporation of the solvent. Optionally, elevated temperature may be used to cure the bond, and if the material of the body parts to be joined are clear materials, they may be instantly cured using high-intensity ultraviolet light.

According to an embodiment of the present invention, the folding knife may be assembled from its two sections and the central hinge component (blade section, handle section, and for example, the pivot ring or pin).

According to an embodiment of the present invention, the blade used in the folding knife of the present invention may be constructed from a ceramic material that is capable of withstanding extended use without becoming dull or unusable. Ceramic materials appropriate for such construction include, but are not limited to, Zirconium Oxide. One of ordinary skill in the art would appreciate that there are numerous ceramic materials that could be utilized with embodiments of the present invention. Alternatively, embodiments of the present invention may be used with standard blades, for example, a metal or steel blade. According to an embodiment of the present invention, the blade may be configured with a rounded tip to reduce the chance of injury.

According to an embodiment of the present invention, the chamber in the handle section to accommodate blade holder and blade may be formed depending on the method of manufacture, for example, by additive or reductive manufacturing/machining. The handle section or parts thereof may be formed during manufacturing (for example, by parts configured to provide a chamber after their assembly, or by configuring a mold accordingly), or may be manufactured without the chamber, and the chamber may then be provided after manufacture of the body by taking away some of the body material with tools suitable for the material of the body (for example, for cutting, broaching, milling, carving, sawing, grinding, boring, or drilling).

According to an embodiment of the present invention, the folding knife may be configured to retain a weight within a hollow cavity of the handle section. When the weight is placed inside the handle section of the folding knife, the weight may be secured in such a manner as hold the weight in place, for example, mechanical fasteners, or a compression fit within an inner wall of the handle section, and optional adhesive. According to an embodiment of the present invention, the weight may be placed towards the back end of the handle section (the end opposite to the blade tip when the folding knife is opened), to add balance to the folding knife, help a user to better control the bladed end, and improve the safety of using the folding knife.

Many suitable methods and corresponding materials to make each of the individual parts of the folding knife handle section, blade section, central hinge components, blade holder and blade are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as described herein-above may be used. Many suitable materials are known and available and can be selected and mixed depending on desired strength and flexibility, preferred manufacturing method and particular use, as will be apparent to a person of ordinary skill in the art.

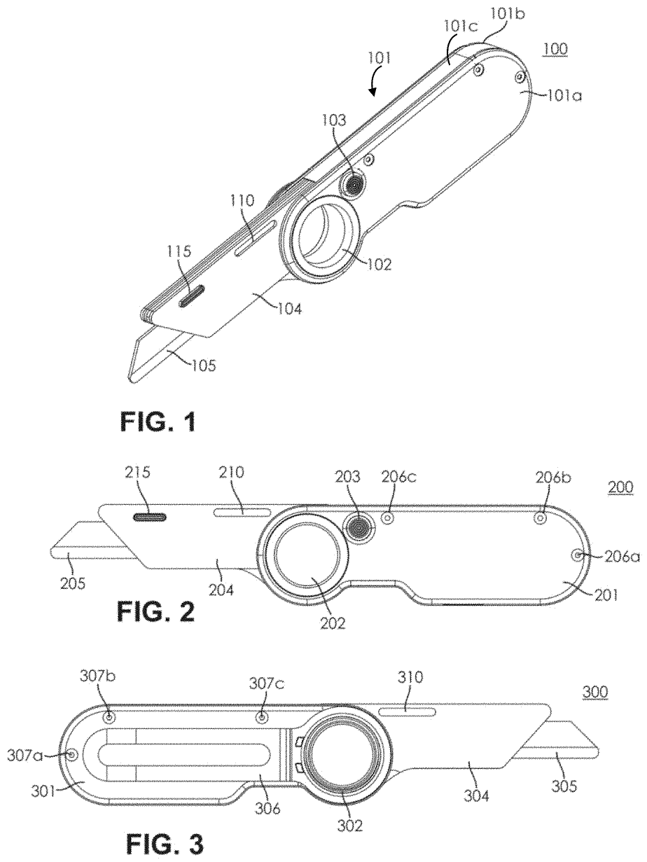

FIG. 1 is an example of a folding knife. The folding knife 100 is shown in an open position. The folding knife 100 may include a handle 101, a pivot ring 102, a release actuator button 103, a blade holder 104, and a blade 105. The handle 101 may be comprised of three pieces: a left side 101a, a right side 101b, and a center connector 101c. The pivot ring 102 may provide an index finger grip and an attachment point for, for example, a carabiner, in addition to a pivoting mechanism.

The blade holder 104 may include an indention 110 and a protrusion 115. The indentation 110 may be used to grab the blade holder 104. The protrusion 115 may lock the blade 105 in place. The protrusion 115 may be pushed to release the blade 105 from the blade holder 104.

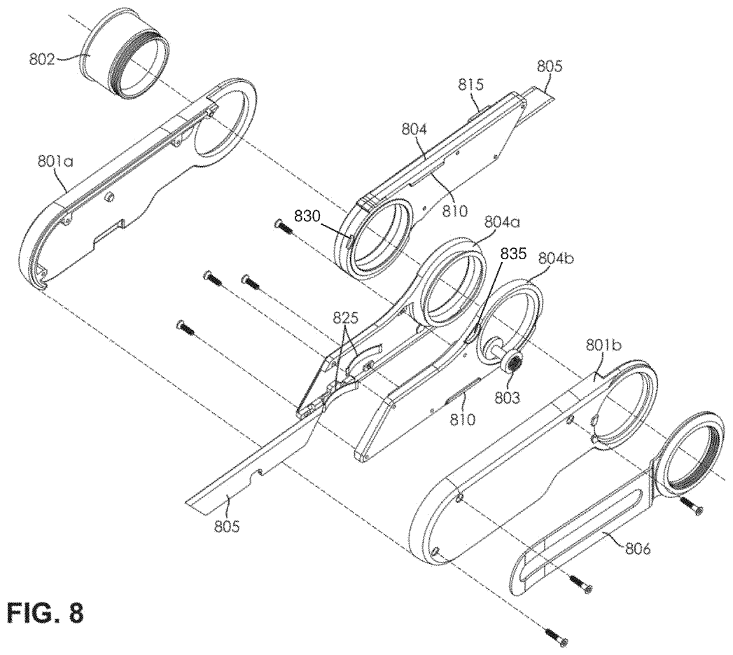

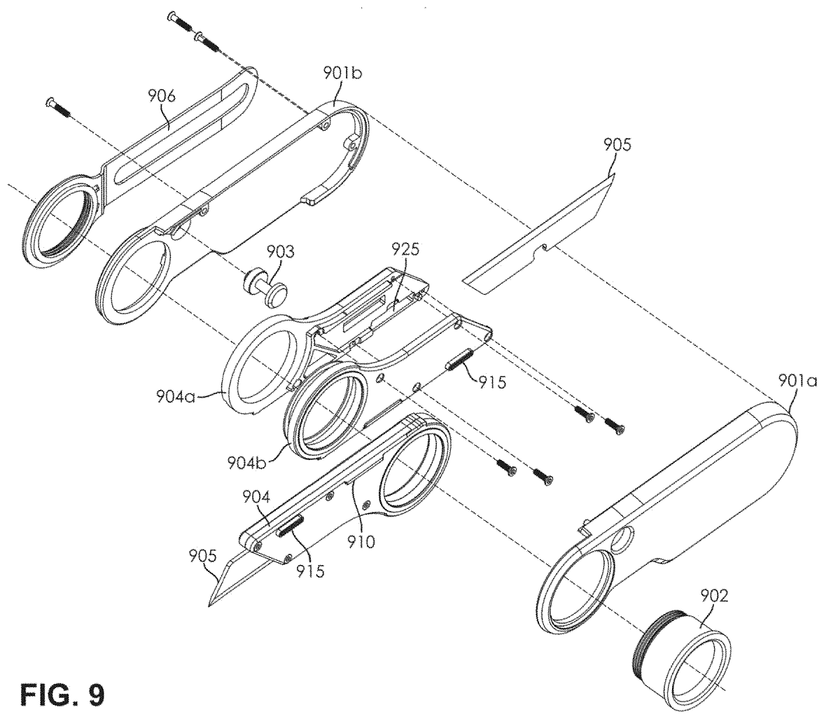

The folding knife 100, having a handle 101 with three pieces 101a, 101b, and 101c, may have the same internal components as illustrated by the exploded views in FIGS. 8 and 9.

FIG. 2 is an example left side view of the folding knife. The folding knife 200 is shown in an open position. The folding knife 200 may include a handle 201, a pivot ring 202, a release actuator button 203, a blade holder 204, and a blade 205. The handle 201 may be joined at three points 206a, 206b, and 206c. The handle 201 may be joined using screws. The pivot ring 202 may provide an index finger grip and an attachment point for, for example, a carabiner, in addition to a pivoting mechanism.

The blade holder 204 may include an indention 210 and a protrusion 215. The indentation 210 may be used to grab the blade holder 204. The protrusion 215 may lock the blade 205 in place.

FIG. 3 is an example right side view of the folding knife. The folding knife 300 is shown in an open position. The folding knife 300 may include a handle 301, a pivot ring 302, and a blade holder 304, and a blade 305. The folding knife 300 may also include a clip attachment 306. The handle 301 may be joined at three points 307a, 307b, and 307c. The pivot ring 302 may provide an index finger grip and an attachment point for, for example, a carabiner, in addition to a pivoting mechanism.

The blade holder 304 may include an indention 310. The indentation 310 may be used to grab the blade holder 304.

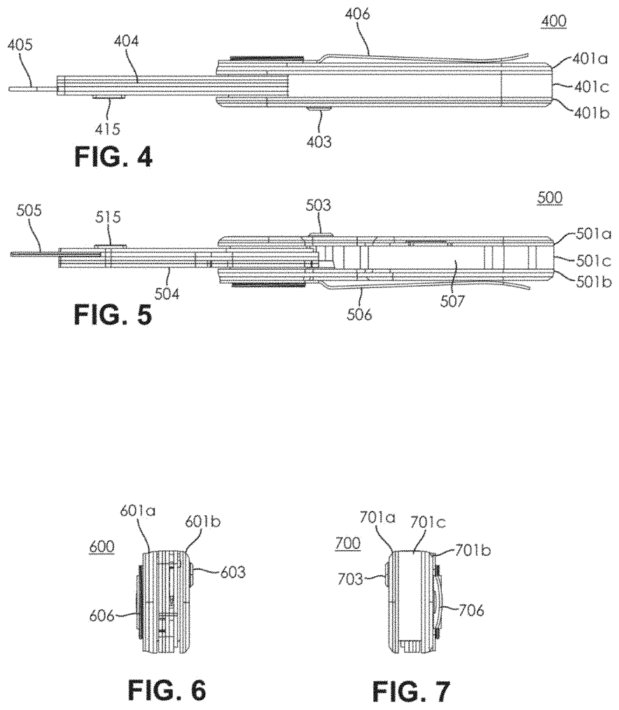

FIG. 4 is an example top view of the folding knife. The folding knife 400 is shown in an open position. The folding knife 400 may include a handle with three pieces 401a, 401b, and 401c. The three pieces 401a, 401b, and 401c may be joined with screws. The folding knife 400 may also include a release actuator button 403, a blade holder 404, and a blade 405. The folding knife 400 may also include a clip attachment 406. The blade holder may include a protrusion 415. The protrusion 415 may lock the blade 405 in place.

FIG. 5 is an example bottom view of the folding knife. The folding knife 500 is shown in an open position. The folding knife 500 may include a handle with three pieces 501a, 501b, and 501c. The three pieces 501a, 501b, and 501c may be joined with screws. The folding knife 500 may also include a release actuator button 503, a blade holder 504, and a blade 505. The folding knife 500 may also include a clip attachment 506. When the folding knife 500 is in the open position (as shown) there may be a cavity (or recess) 507. The cavity 507 may receive the blade holder 504 when the folding knife 500 is in a closed position. The blade holder may include a protrusion 515. The protrusion 515 may lock the blade 505 in place.

FIG. 6 is an example front view of the folding knife. The folding knife 600 may include a handle with pieces 601a and 601b (from this view the third piece is not visible). The folding knife may also include a release actuator button 603 and a clip attachment 606.

FIG. 7 is an example rear view of the folding knife. The folding knife 700 may include a handle with three pieces 701a, 701b, and 701c. The three pieces 701a, 701b, and 701c may be joined with screws. The folding knife 700 may also include a release actuator 703 and a clip attachment 706.

FIG. 8 is a first example exploded view of the folding knife. The folding knife 800 is shown in both the open and closed positions. The open position is illustrated by the blade holder in one piece while the closed position is illustrated by the blade holder separated into a two piece housing and shows how the blade is held in place.

The folding knife 800 may include a handle having two pieces 801a and 801b, a pivot ring 802, a release actuator button 803, a blade holder 804 (and 804a and 804b in the closed position), a blade 805, and a clip attachment 803. The handle pieces 801a and 801b may be joined using screws. When the handle pieces 801a and 801b are joined together a cavity or recess is created for receiving the blade holder 804 in the closed position.

The pivot ring 802 may provide an index finger grip and an attachment point for, for example, a carabiner, in addition to a pivoting mechanism. The pivot ring 802 may be inserted into each circular opening in the handle 801a and 801b, the blade holder 804, and the clip attachment 806.

The blade holder 804 may be a two-piece housing 804a and 804b as illustrated in the closed position. The two-piece housing 804a and 804b may be joined with screws. The two-piece housing 804a and 804b may receive the blade 805. The blade holder 804 may include an indention 810 and a protrusion 815. The indentation 810 may be used to grab the blade holder 804. The protrusion 815 may lock the blade 805 in place. The blade 805 may be notched and secured in the blade holder 804 with leaf springs 825. The protrusion 815 may be depressed to release the leaf springs 825 and remove the blade 805 from the blade holder 804.

FIG. 9 is a second example exploded view of the folding knife. The exemplary folding knife is shown in both the open and closed positions. The open position is illustrated by the blade holder in one piece while the closed position is illustrated by the blade holder separated into a two piece housing and shows how the blade is held in place.

The exemplary folding knife may include a handle having two pieces 901a and 901b, a pivot ring 902, a release actuator button 903, a blade holder 904 (and 904a and 904b in the closed position), a blade 905, and a clip attachment 906. The handle pieces 901a and 901b may be joined using screws. When the handle pieces 901a and 901b are joined together a cavity is created for receiving the blade holder 904 in the closed position.

The pivot ring 902 may provide an index finger grip and an attachment point for, for example, a carabiner, in addition to a pivoting mechanism. The pivot ring 902 may be inserted into each circular opening in the handle 901a and 901b, the blade holder 904, and the clip attachment 906.

The blade holder 904 may be a two-piece housing 904a and 904b as illustrated in the closed position. The two-piece housing 904a and 904b may be joined with screws. The two-piece housing 904a and 904b may receive the blade 905. The blade holder 904 may include an indention 910 and a protrusion 915. The indentation 910 may be used to grab the blade holder 904. The protrusion 915 may lock the blade 905 in place. The blade 905 may be notched and secured in the blade holder 904 with leaf springs 925. The protrusion 915 may be depressed to release the leaf springs 925 and remove the blade 905 from the blade holder 904.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature rather than restrictive.

What is claimed is:

1. A folding knife comprising:
a handle;
a blade holder, wherein the blade holder is selectively received in the handle;
a pivot ring, wherein the blade holder is rotatably connected to the handle via the pivot ring;
a blade, wherein the blade is housed in the blade holder; and
a release actuator button, wherein the release actuator button is actuatable between a first position and a second position in a direction perpendicular to a rotational direction of the rotatably connected blade holder;
wherein the blade holder includes a blade lock;
wherein, based on an actuation of the release actuator button between the first position and the second position, the blade holder is rotatable between a closed position in which the blade holder is received in the handle, an open position in which the folding knife is open, and an intermediate position located between the closed position and the open position;
wherein the pivot ring includes an aperture;
wherein the blade holder includes an aperture configured to receive the pivot ring;
wherein the blade holder includes one or more protrusions disposed adjacent to the aperture of the blade holder; and
wherein the one or more protrusions protrude from a surface of the blade holder in the direction perpendicular to the rotational direction of the rotatably connected blade holder.

2. The folding knife of claim 1, wherein:
the blade lock is a protrusion;
when the protrusion is depressed, the blade is released from the blade holder; and
the blade lock automatically returns to a locked position when the protrusion is released.

3. The folding knife of claim 2, wherein the blade lock returns to the locked position by a spring.

4. The folding knife of claim 3, wherein the spring is a leaf spring.

5. The folding knife of claim 1, wherein the pivot ring is a hollow cylinder disposed in an opening of the handle and the aperture of the blade holder.

6. The folding knife of claim 1, wherein when the blade holder is in the open position or the closed position, the release actuator button is in the first position to prevent rotation of the blade holder about the pivot ring.

7. The folding knife of claim 1, wherein the release actuator button being in the second position allows rotation of the blade holder about the pivot ring to the intermediate position.

8. The folding knife of claim 1, wherein when the blade holder moves from the intermediate position to either the open position or the closed position, the release actuator button automatically moves from the second position to the first position.

9. The folding knife of claim 1, wherein the release actuator button has an outer end portion and an inner end portion, each of the outer end portion and the inner end portion having a larger diameter than a middle portion disposed between the outer end portion and the inner end portion.

10. The folding knife of claim 9, wherein when the release actuator button is disposed in the first position, which prevents rotation of the blade holder about the pivot ring, one or more sides of the inner end portion engages the one or more protrusions of the blade holder, the one or more protrusions, which protrude from the surface of the blade holder in the direction perpendicular to the rotational direction of the rotatably connected blade holder, abutting against the inner end portion.

11. The folding knife of claim 10, wherein when the release actuator button is disposed in the second position, which allows rotation of the blade holder about the pivot ring to the intermediate position, the middle portion allows free movement of the one or more protrusions of the blade holder.

12. The folding knife of claim 1, wherein the handle includes an aperture configured to receive the pivot ring.

13. The folding knife of claim 1, wherein the blade is a ceramic blade.

14. A folding knife, comprising:
a handle;
a blade holder, wherein the blade holder is selectively received in the handle;
a pivot member, wherein the blade holder is rotatably connected to the handle via the pivot member;
a blade, wherein the blade is housed in the blade holder; and
a release actuator, wherein the release actuator is actuatable between a first position and a second position;
wherein the blade holder includes a blade lock;
wherein, based on an actuation of the release actuator between the first position and the second position, the blade holder is rotatable between a closed position in which the blade holder is received in the handle, an open position in which the folding knife is open, and an intermediate position located between the closed position and the open position;
wherein the release actuator has an outer end portion and an inner end portion, each of the outer end portion and the inner end portion having a larger diameter than a middle portion disposed between the outer end portion and the inner end portion;
wherein the pivot member includes an aperture configured to receive a user's finger;
wherein the blade holder includes an aperture configured to receive the pivot member;
wherein the blade holder includes a plurality of protrusions disposed adjacent to the aperture of the blade holder; and
wherein the plurality of protrusions protrude from a surface of the blade holder in a direction perpendicular to a rotational direction of the rotatably connected blade holder.

15. The folding knife of claim 14, wherein the release actuator has a barbell shape.

16. The folding knife of claim 14, wherein the release actuator is actuatable between the first position and the second position in the direction perpendicular to the rotational direction of the rotatably connected blade holder.

17. The folding knife of claim 14, wherein when the release actuator is disposed in the first position, which prevents rotation of the blade holder about the pivot member, one or more sides of the inner end portion engages one of the plurality of protrusions of the blade holder, the one of the plurality of protrusions, which protrudes from the surface of the blade holder in the direction perpendicular to the rotational direction of the rotatably connected blade holder, abutting against the inner end portion.

18. The folding knife of claim 17, wherein when the release actuator is disposed in the second position, which allows rotation of the blade holder about the pivot member to the intermediate position, the middle portion allows free movement of the plurality of protrusions of the blade holder.

19. A folding knife, comprising:
a handle;
a blade holder, wherein the blade holder is selectively received in the handle;
a pivot member, wherein the blade holder is rotatably connected to the handle via the pivot member;
a blade, wherein the blade is housed in the blade holder; and
a release actuator, wherein the release actuator is actuatable between a first position and a second position;
wherein the blade holder includes a blade lock;
wherein, based on an actuation of the release actuator between the first position and the second position, the blade holder is rotatable between a closed position in which the blade holder is received in the handle, an open position in which the folding knife is open, and an intermediate position located between the closed position and the open position;
wherein the release actuator has a barbell shape;
wherein the release actuator is actuatable between the first position and the second position in a direction perpendicular to a rotational direction of the rotatably connected blade holder;
wherein the pivot member includes an aperture configured to receive a user's finger;
wherein the blade holder includes an aperture configured to receive the pivot member;
wherein the handle includes an aperture configured to receive the pivot member;
wherein the blade holder includes at least one protrusion disposed adjacent to the aperture of the blade holder; and
wherein the at least one protrusion protrudes from a surface of the blade holder in the direction perpendicular to the rotational direction of the rotatably connected blade holder.

20. The folding knife of claim 19, wherein when the release actuator is disposed in the first position, which prevents rotation of the blade holder about the pivot member, one or more sides of the release actuator engages the at least one protrusion of the blade holder, the at least one protrusion, which protrudes from the surface of the blade holder in the direction perpendicular to the rotational direction of the rotatably connected blade holder, abutting against the one or more sides of the release actuator.
